(19) United States
(12) Patent Application Publication
(10) Pub. No.: US 2026/0251156 A1
(43) Pub. Date: Aug. 27, 2026

(54) FLOW MACHINE AND METHOD FOR PRODUCING A FLOW MACHINE COMPONENT GUIDING A FLOW MEDIUM

(71) Applicant: ZIEHL-ABEGG SE, Künzelsau (DE)

(72) Inventors: Frieder LOERCHER, Braunsbach (DE); Andreas GROSS, Kirchensall (DE)

(21) Appl. No.: 19/135,214

(22) PCT Filed: Dec. 5, 2023
(86) PCT No.: PCT/DE2023/200244

§ 371 Date: Jun. 3, 2025

(30) Foreign Application Priority Data
Dec. 16, 2022 (DE) 10 2022 213 765.5

(51) Int. Cl. F04D 29/54; B29C 45/37; B29K 101/12; B29L 31/08; F04D 29/02; F04D 29/66

(52) U.S. Cl. CPC F04D 29/542; B29C 45/372; F04D 29/023; F04D 29/667; B29K 2101/12; B29L 2031/082

(57) ABSTRACT

A flow machine, such as turbomachine like a fan, having at least one component guiding a flow medium, for example blades of an impeller, guide vanes, hub ring, cover ring, base disc, nozzle or housing parts/components. The component guiding the flow medium is produced by casting such as injection moulding from plastic. Riblets are formed at least partially on and/or in the surface of the component in a region around which flow takes place.

### CROSS REFERENCE

This application is a national stage entry application under 35 U.S.C. 371 of PCT Patent Application No. PCT/DE2023/200244 filed on 5 Dec. 2023, which claims priority to German Patent Application No. 10 2022 213 765.5, filed on 16 Dec. 2022 the entire contents of each of which are incorporated herein by reference.

### FIELD

The present disclosure relates to a flow machine, such as a turbomachine, such as a fan, with at least one component that guides a flow medium, such as, for example, blades of an impeller, guide blades, hub ring, cover ring, base plate, nozzle, or housing parts/components, etc.

Furthermore, the present disclosure relates to a method for producing a component of a flow machine which guides a flow medium.

### BACKGROUND

Flow machines of the type discussed here are well known from practical experience. Fans and their components are just one example of this. In such flow machines, wall friction poses a problem both in terms of operating noise and also in terms of power consumption and efficiency. Consequently, measures must be taken to reduce wall friction.

It is already known from practical experience that riblets on flowed-around surfaces reduce wall friction and thus reduce friction losses and additional load torques. This also applies to flow machines, such as turbomachines or fans. It can be of interest to equip components which are both stationary and during operation also rotate or move with such riblets.

Riblets are raised, elongated structures on flowed-around surfaces and are advantageously oriented along their length approximately in the direction of the relative flow velocity in the area of the surface. In order to achieve the effect of reducing wall friction, special requirements must be met for the cross-sections of the riblets, depending on the relative flow velocities. The dimensions of the riblets are rather small when viewed in the cross-section; for example, the widths, distances between adjacent riblets, and heights of the riblets are advantageously in the range of 1 μm to 100 μm.

In general, a large number of riblets must be arranged next to one another in order to cover a surface around which flow takes place. For these reasons, a large-scale manufacturing process which is suitable for producing high quantities per unit of time is not known in the prior art. Known manufacturing methods include applying, for example by adhering, riblet-coated films or incorporating riblets into prefabricated components by means of laser processing, machining or other subsequent surface modifications.

### SUMMARY

The present disclosure is based on the object of specifying a flow machine, in particular a turbomachine, such as a fan and its components, in which wall friction-reducing riblets can be realized in a cost-effective manner. The use of riblets is to be cost-effective in flow machines. Above all, it should be possible to produce appropriate components for flow machines simply and cost-effectively, depending on the relative flow velocities. In addition, the flow machine according to the present disclosure should differ from competitive products.

With regard to the flow machine according to the present disclosure, the object of the present disclosure is achieved by the features of the claims. Accordingly, the component which guides the flow medium and which is important in each case is produced from synthetic material by casting, such as injection molding. At least some riblets are formed on and/or in the surface of the component, in each case in an area around which flow takes place and which is therefore important, such riblets being easily integrated into the component, namely on the basis of casting technology.

In an embodiment, the riblets are formed in an area of high flow losses or high wall friction losses and/or noise generation on the respective component. This measure reduces wall friction in relevant areas.

The riblets are designed as elongated, raised structures, in a embodiment, that run approximately parallel to the direction of flow over them. They can be straight or curved. In addition, multiple riblets can be arranged next to one another in an arrangement suitable for the specific component, where appropriate with multiple such arrangements arranged at least to a great extent parallel to one another. If there are multiple rows of such riblets arranged next to one another, they can be arranged at equal distances from one another.

It is also conceivable that the arrangement of the riblets describes a circular arc or an involute curve. The arrangement of the riblets can otherwise be curved, wherein the individual riblets are arranged next to one another. If necessary, two or more such arrangements can advantageously be formed approximately parallel to one another.

In a further embodiment, the riblets are all or at least predominantly free of undercuts with regard to a demolding direction of the tools. Another advantage is a draft angle of at least 1°, and at least 3° in another embodiment.

The side flanks of the riblets can be designed asymmetrically or non-symmetrically with respect to a local normal on the riblet-free imaginary base area of the respective components, which facilitates the removal of the tool in a specific demolding direction that is tailored to or required by the component geometry.

The respective component, including the riblets, can be demolded in one piece and free of undercuts from a casting tool, namely due to the specific design of the riblets.

It is also conceivable that at least the area of the riblets is made of a thermoplastic synthetic material, with fiber reinforcement in an embodiment. This promotes stability. Abrasion is reduced.

With regard to the method according to the present disclosure, the object mentioned at the beginning is achieved by the features of the claims, wherein the component guiding the flow medium is equipped with riblets at least in some areas. Here too, the production method using casting technology is used, in an embodiment, wherein the components are produced by injection molding using shaping tools. Negative contours of the riblets are incorporated into the tools. Due to the reference of the method according to the present disclosure to the flow machine according to the present disclosure, the relevant features are also incorporated into the method according to the present disclosure.

In an embodiment, the tool surfaces into which the negative contours of the riblets are incorporated are surface-treated to obtain a low degree of roughness or roughness depth, for instance, a roughness depth of less than 10 μm, or even less than 4 μm, before the riblet contours are incorporated. The surfaces can be ground or honed in an embodiment.

It is also conceivable that the contours of the riblets could be added to the tool at a later stage, for instance to a tool that has already been put into operation for production. This allows an existing tool to be reworked with regard to the riblets.

It is advantageous to design the tools in such a way that in areas where riblets are intended, a higher wall temperature of the tool is provided during manufacture, for example at least 5 K higher than in other areas of the tool surface. This can be achieved, for example, by a separate cooling circuit with an increased flow temperature, or by other targeted measures relating to the tool cooling system. This results in better molding of the riblets, since synthetic material can flow more easily into the small-scale recesses that form the riblets, which would otherwise be at risk of not being filled with synthetic material.

The riblets are designed in the cross-section in such a manner that the wall friction-reducing effect is ensured, while at the same time maintaining a high degree of stability of the riblets on the component and robustness of the tool against erosion or other signs of wear. For example, undercut-free demoldability.

There are now various possibilities for designing and developing the doctrine of the present disclosure. Reference should be made on the one hand to the claims and on the other hand to the following description of exemplary embodiments of a fan according to the present disclosure with reference to the drawings. In conjunction with the explanation of the exemplary embodiments of the disclosure with the aid of the drawings, generally designs and developments of the doctrine are also explained.

### BRIEF DESCRIPTION OF THE DRAWINGS

FIG. 1 shows, in a perspective view viewed from the inflow side, an impeller of an axial fan with a schematically represented course of riblets on air-guiding surfaces,

FIG. 2 shows, in a detailed section, a schematic representation of a prior art of riblets on the air-guiding surface of a component of a flow machine, including the associated shaping tool, viewed in a section on a plane locally approximately perpendicular to the air-guiding surface or its base area and approximately perpendicular to the longitudinal course of the riblets,

FIG. 3 shows a representation comparable with FIG. 2, wherein according to the present disclosure modified riblet geometries are formed for the undercut-free demolding.

FIG. 4 shows, in a planar view viewed from the inflow side, an impeller of a radial fan with a schematically represented course of riblets on air-guiding surfaces,

FIG. 5 shows, in a planar view viewed from the outflow side, an impeller of a radial fan with a schematically represented course of riblets on air-guiding surfaces, and

FIG. 6 shows, in a perspective view viewed from the inflow side, a housing of an axial fan with a schematically represented course of riblets on air-guiding surfaces.

### DETAILED DESCRIPTION OF THE DISCLOSURE

FIG. 1 shows, in a perspective view viewed from the inflow side, an impeller 19 of a fan of an axial construction. The impeller 19 is a rotating component of a fan (not shown in its entirety), in other words, a flow machine and, in particular, a turbo flow machine, and is driven in the case of the assembled fan by a motor to which it is attached in order to convey a flow medium. It essentially comprises a hub ring 21 and blades 22 attached to it. The impeller 19 is a flowed-around component 1 of a flow machine, in particular of a turbomachine and, more specifically of a fan with air-guiding surfaces 13, in particular on the surfaces of the blades 22 on their suction and pressure sides but also on the hub ring 21.

During operation, relative velocities between the conveying medium and the flowed-around surfaces 13 cause wall shear stresses, which contribute to an increase in the drive power and/or a reduction in the delivery flow rate. A reduction in wall shear stresses at comparable operating points, in other words also at comparable relative flow velocities of the flow, can therefore result in a reduction in drive power and/or an increase in the delivery flow rate and thus an increase in efficiency. Noise generation can also be reduced by reducing wall shear stresses.

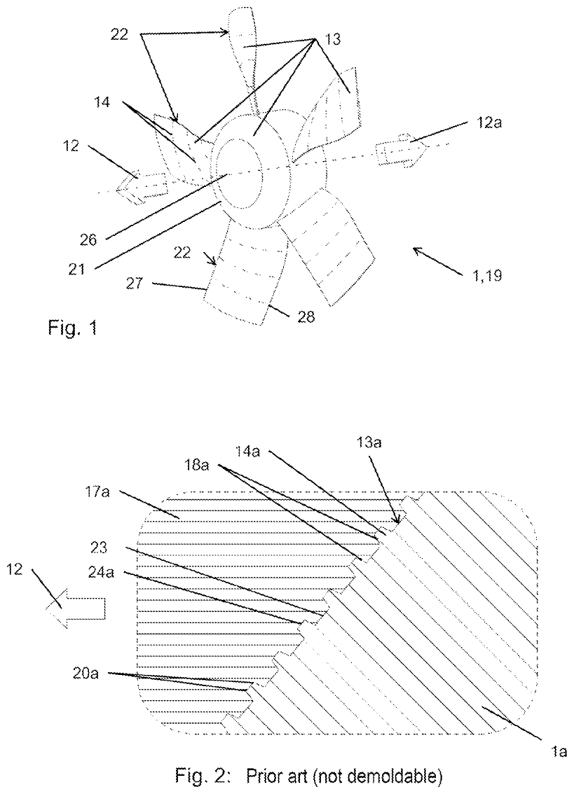

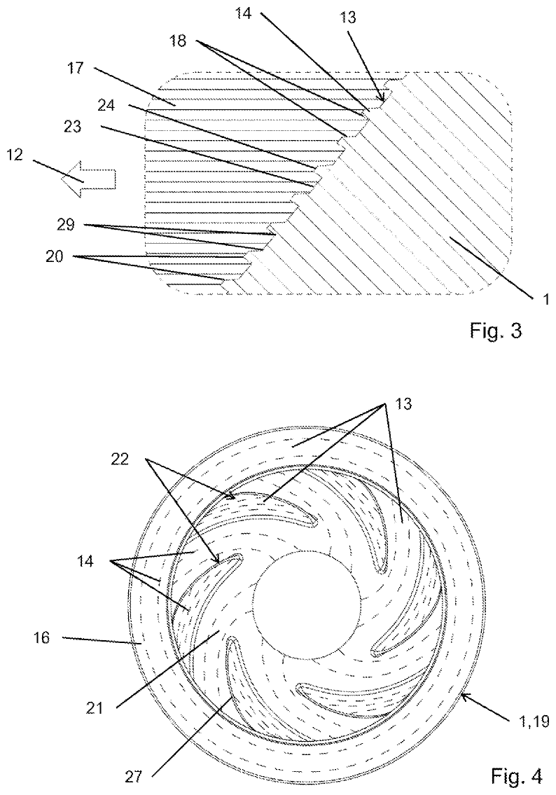

The cross-sectional design of the riblets is described with the aid of FIG. 2 and FIG. 3. In the impeller 19 according to FIG. 1, riblets 14 are now formed on the air-guiding surfaces 13 of the blades 22. The longitudinal course of some riblets 14 is shown schematically. Physically, a very large number of riblets 14 are formed parallel to and at a short distance from one another, for clarity, only the course of a few riblets 14 is shown. The riblets 14 run to a great extent parallel to the relative flow on the flowed-around surfaces 13 of the blades 22 from the inflow edges 27 to the outflow edges 28. It is also conceivable that the riblets 14 run only over part of the blades 22 along their length or that they cover only part of the blades 22, for example in areas with particularly high flow losses or noise generation due to wall shear stresses. It is also conceivable that riblets are formed on the flowed-around surface 13 of the hub ring 21, although this is not provided for here.

In order to manufacture the impeller 19, the component 1 of the flow machine, in an economic manner, the component 1, 19, including the riblets 14, is produced according to the present disclosure in a single piece in a casting process, advantageously in synthetic material injection molding. This renders it possible to produce high volumes. The negative contours of the riblets 14 are therefore incorporated into the corresponding shaping surfaces of the casting tool in a suitable manner (see also the description of FIG. 2 and FIG. 3). The impeller 19 in FIG. 1 is manufactured using a tool that comprises among other things two essential shaping parts.

During the demolding of the component, the one shaping part which mainly forms the impeller surfaces which are visible in the illustration shown and face the inflow side moves in the demolding direction 12, approximately to the left away from the component 1. The other shaping part of the casting tool which mainly forms the impeller surfaces which are not visible in the illustration shown and are facing the outflow side moves in a different demolding direction 12a during the demolding process, approximately to the right away from component 1. Since the component 1 has a complex geometry with three-dimensionally twisted blades 22, these demolding directions are to a great extent predetermined by this basic geometry.

With such components, the demolding directions cannot be adapted to any undercuts that can arise as a result of the riblets 14, or can only be adapted with great difficulty and at great expense. The demolding directions 12, 12a are often not parallel to local wall normal directions of the flowed-around surfaces 13, as is also the case here with the inflow and outflow sides of the blades 22. For this reason, it has not been possible to mold such components 1 in a single casting. Riblets can be implemented in the prior art by means of special riblet-coated films which are applied to components or by laser processing of components. However, these technologies do not allow for low production times or production costs and high quantities.

In order to illustrate the problem of demoldability of riblets integrated into cast parts, FIG. 2 shows, in a detailed sectional view, a schematic representation of a prior art of riblets 14a on the air-guiding surface 13a of a component 1a of a flow machine, including the associated shaping tool part 17a, in a section in a plane approximately perpendicular to the air-guiding surface 13a or its base area 23a and approximately perpendicular to the longitudinal course of the riblets 14a. A remolding direction 12 for a tool part 17a relative to the component 1a of the air-guiding component 1a is shown. This demolding direction 12 can be seen as a projection into the plane of representation; the actual demolding direction can additionally have a component perpendicular to the drawing plane in three dimensions.

According to the prior art, the riblets 14a viewed in the cross-section are each formed approximately symmetrical to an imaginary local normal to the air-guiding surface 13a or its base area 24a. The base area 24a corresponds to the course of the air-guiding surface 13a imagined without riblets. The riblets 14a each have at their center measured in the cross-section a lateral distance from the next adjacent riblet 14a (measured transversely to their longitudinal direction of extent), namely a jump dimension, as well as a height above the base area. Advantageously, the height above the base area corresponds to 15% to 70% of the jump dimension. The riblets 14a each have two side flanks 18a which are not parallel to each other but are at a wedge angle to each other, which is advantageously 10° to 50°.

Now, in the prior art as shown, undercuts are formed on the riblets 14a on their side flanks 18a (in the figure on the upward-facing side flanks 18a), as can be clearly seen from the hatching of the tool part 17a running parallel to the demolding direction 12 specified by the component. This is because the demolding direction 12 specified by component 1a deviates significantly from the local wall normal directions to the flowed-around surfaces 13a. This is regularly the case with complex three-dimensional and flow-optimized components 1a of flow machines, such as impellers of axial or radial design, inlet nozzles, housings, or guide facilities. If the demolding shown here were to be carried out with the demolding direction 12 as forced demolding, the riblets 14a would be destroyed during the demolding process. This is because well-formed side flanks 18a and base areas 23 of the riblets 14a are crucial for the proper flow-related functioning of the riblets 14a, also the implementation of the ratio of the height of the riblets 14a to the jump dimension between two adjacent riblets 14 a of 15% to 70%.

FIG. 3 shows, in a representation comparable to FIG. 2, an embodiment of a flowed-around surface 13 of a component 1 of a flow machine, the embodiment being adapted to the manufacturing method or the demolding process according to the present disclosure and the flowed-around surface being provided with riblets 14. FIG. 3 shows, in a detailed section, a schematic representation of a flowed-around component 1, with riblets 14 on the air-guiding surface 13 of a component 1 of a flow machine, including the associated shaping tool part 17, in a section on a plane locally approximately perpendicular to the air-guiding surface 13 or its base area 23 and approximately perpendicular to the longitudinal course of the riblets 14. The figure shows a demolding direction 12 for a tool part 17 relative to the component 1, the air-guiding component 1. This demolding direction 12 can be seen as a projection into the plane of representation; the actual demolding direction can additionally have a component perpendicular to the drawing plane in three dimensions.

For undercut-free demolding, riblet geometries modified with respect to the prior art shown in FIG. 2 are formed, which nevertheless essentially have the function of reducing wall friction during operation of the flow machine. The riblets 14 and their cross-section are now designed modified in a manner taking into account the demolding direction 12 specified by component 1. Thus, the riblets 14, in a cross-section as shown, for example, in FIG. 3, are not symmetrical to imaginary local normals to the air-guiding surface 13 or its base area 23. Accordingly, the two side flanks 18 of the respective riblets 14 are not symmetrical to an imaginary local normal to the air-guiding surface 13 or its base area 23. The two outer angles which the two side flanks 18 of a riblet 14 have with respect to the base area 23 in areas in which the demolding direction 12 deviates significantly, for example by more than 25°, from the imaginary local normal to the base area 23 of the air-guiding surface 13, differ significantly from one another, for example by more than 10°. The shaping tool part 17 has the negative shape of the component 1 provided with riblets 14, the flowed-around component 1, whereby the aforementioned design features of the riblets 14 are also found on the tool part 17.

The course of the side flanks 18 is adapted in the cross-section to the demolding direction 12 in such a way that the riblets 14 can be demolded essentially free of undercuts in the demolding direction 12, also advantageously, as shown in FIG. 3, there is a draft angle of at least 1°, advantageously 3°, with respect to the demolding direction 12. The undercut-free demoldability can be clearly verified in FIG. 3 with the aid of the hatching of the section through the tool part 17, which is parallel to the (projected) demolding direction 12. In this embodiment, the riblets 14 are not damaged or destroyed during the demolding process.

In order to still have the function of reducing wall shear stress, essential design features of the riblets 14 have been taken into account. Measured at their center in the cross-section, the riblets 14 each have a lateral distance from the next adjacent riblet 14 (measured transversely to their longitudinal direction of extent), namely a jump dimension, as well as a height above the base area.

Advantageously, the height above the base area corresponds to 15% to 70% of the jump dimension. The riblets 14 each have two side flanks 18 which are not parallel to each other but are at a wedge angle to each other, which is advantageously 10°-50°. In the exemplary embodiment, upper end faces 24 are formed on the riblets 14, which are advantageous for the stability and durability of the riblets 14. Advantageously, the width of the end faces 24 of the riblets 14, viewed in the cross-section, is in a range of about 30-200% of the height of the riblet 14 in question. Embodiments without end faces 24 are also conceivable, for example if the riblets or their side flanks merge into one another at their outer ends in a pointed manner or with a rounding.

In the exemplary embodiment, pronounced outer edges 20 are provided at the transition of the side flanks 18 to the end faces 24. Here too, it is advantageously conceivable in the case of other embodiments to round these outer edges 20 with small transition radii.

Similarly, in the exemplary embodiment, pronounced inner edges 29 are provided at the transition of the side flanks 18 to the base area 23. Here too, it is advantageously conceivable to round these inner edges 29 with small transition radii in other embodiments. The rounding increases in each case the stability of the component 1 or the riblets 14 thereon and the shaping tool part 17, and reduces wear during manufacture and also during operation of the flow machine with the air-guiding component 1 with the riblets 14. The radius of curvature for possible roundings of the outer edges 20 or the inner edges 29 is advantageously in a range of at most 30% of the height of the respective riblets 14.

The areas of the inner edges 29 can be rounded with a variable radius of curvature, similar to that of tree trunks, which is particularly advantageous. The radii of curvature at the transition to the base area 23 are smaller than at the transition to the side flank 18, advantageously by a factor of at least 1.4.

In the embodiment shown, the flowed-around component 1 including the riblets 14 can be demolded in one piece and free of undercuts from a casting tool. The riblets 14 are not damaged or destroyed during demolding. Components 1 can be manufactured in large quantities at low cost. In order to fill the riblet contours of the tool part 17 well with casting material, suitable process parameters and materials must be selected in the case of synthetic material injection molding of thermoplastics, which can also be provided with reinforcing fibers. It is advantageous to use materials with good flow properties and well-heated tool surfaces in the area of the riblets 14. The holding pressure time should be rather long and the holding pressure rather high. Tool areas that form riblets can be advantageously tempered at least partially higher than other tool areas that do not form riblets locally, by at least 10 K.

The demolding direction 12 shown in FIG. 3 is to be understood as a projection into the plane of representation. The actual three-dimensional demolding direction can therefore also have a component perpendicular to the plane of representation.

However, this component perpendicular to the plane of representation would be parallel to the longitudinal course of the riblets 14. In this respect, this directional component of the demolding direction perpendicular to the plane of representation would be irrelevant with respect to the occurrence of possible undercuts. The special measures on the riblets 14 which ensure undercut-free demoldability, the asymmetrical design of the two side flanks 18 of a riblet 14 relative to each other, are necessary particularly then and in such areas of a flowed-around surface 13 of a flowed-around component 1 if the angle between the demolding direction 12 projected into the plane of representation according to FIG. 3 and the local wall normal to the base surface 23 is greater than 20°, or even greater than 45°, in other words when the projected demolding direction is not parallel to the local wall normal to the base area 23. This is typically the case for a significant proportion of the flow-guiding surfaces 13 of a flowed-around component 1, the flow-guiding surfaces being provided with riblets 14, for example for more than 25% or more than 50% of the flowed-around surfaces.

FIG. 4 shows, in a planar view viewed from the inflow side, an impeller 19 of a radial fan with a schematically represented course of riblets 14 on air-guiding surfaces 13. The impeller 19 in the exemplary embodiment has a radial design and comprises a hub ring 21 (also referred to as a base plate in the case of radial impellers), a cover ring 16 and blades 22 extending between them.

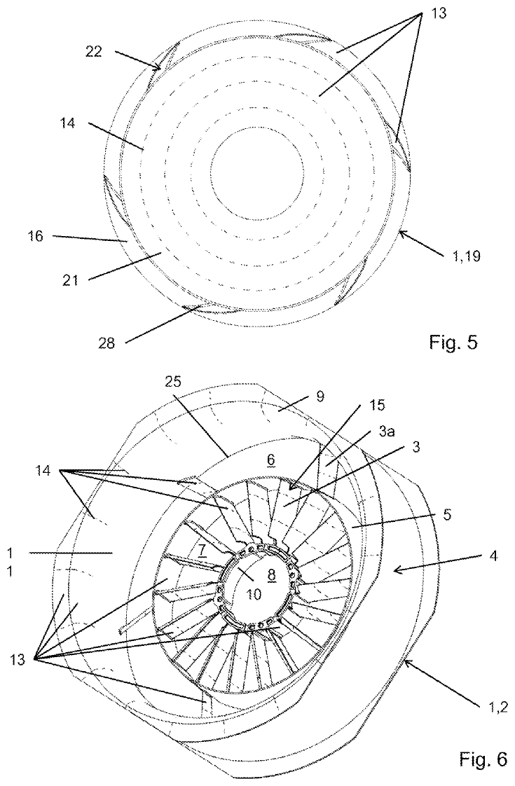

During operation of the radial fan, the impeller 19 rotates about the central axis of symmetry and thereby conveys a conveying medium in a conveying direction approximately from the inflow edges 27 of the blades 22 to the outflow edges 28 (FIG. 5). The conveying medium enters the impeller 19 through the central opening in the cover ring 16 and is conveyed radially outward. In any case, the impeller 19 is a flowed-around component 1 of a flow machine, in this case a fan. The reduction of wall shear stresses with the aid of riblets 14 on flowed-around surfaces 13 serves to reduce the drive torque and/or increase the delivery flow rate and thus increase efficiency. This can also reduce noise generation during operation. In the exemplary embodiment, riblets 14 are schematically shown as examples on various flow-guiding surfaces 13.

As shown in FIG. 1, only the directional courses of a few riblets 14 are indicated; in practice, a large number of riblets 14 run at a short distance from one another on flowed-around surfaces 13. Flowed-around surfaces 13 are shown here as an example on the visible outer side of the cover ring 16, where the relative flow velocity runs approximately in the circumferential direction, which is why the riblets 14 run in the circumferential direction. The relative demolding direction of a tool part demolding the outer side of the cover ring 16 would normally be approximately perpendicular to the plane of representation. Due to the three-dimensional contour of the cover ring 16, the demolding direction is not perpendicular to the base area of the outer side of the cover ring 16 everywhere, and the riblets 14 are designed in areas where necessary according to the present disclosure as shown in FIG. 4 in order to avoid undercuts. Riblets 14 are also provided on the inner surface of the hub ring 21 visible in FIG. 4, which is also a flowed-around surface 13, and the riblets 14 are oriented in the relative flow direction to be expected there.

The hub ring 21 or its base area is also generally not planar and not parallel to the plane of representation, but is designed, for example, as a rather conical rotation body, which is why also here the expected demolding direction of the shaping tool part is often not perpendicular to the flowed-around base area and also not parallel to the course of the riblets 14, which is why the geometric design of the riblets 14 is adapted according to the description of FIG. 4 in order to avoid undercuts. The situation is very similar with the riblets 14 which are designed on the flowed-around surfaces 13 of the blades 22.

Not all air-guiding surfaces 13 of a component 1 need to be provided with riblets 14, depending on the influence of the local wall friction, some air-guiding surfaces 13 can only be provided with riblets in part or not at all. The design of the riblets 14 depends on the demolding direction of the tool part relative to the flowed-around surface 13 of component 1 and the longitudinal orientation of the riblets 14 in situ. If it is not necessary to redesign of the riblets 14 locally for undercut-free demolding, this can of course be advantageously omitted.

For the sake of completeness, it should be mentioned at this point that embodiments of impellers of axial fans with a circumferential cover ring are also conceivable, wherein the cover ring connects the radially outer blade tips to one another in the circumferential direction. The attachment of riblets to such a cover ring is also advantageous.

FIG. 5 shows, in a planar view viewed from the downstream side, an impeller 19 as a flowed-around component 1 of a radial fan similar to that shown in FIG. 4. The trailing edges 28 of the blades 22, which are located approximately in the area of the outlet of the flow of the fan during operation, are visible. Riblets 14 are attached to the visible outer side of the hub ring 21, a flowed-around surface 13.

The hub ring 21 or its base area is advantageously not planar. The riblets 14 run approximately in the circumferential direction on the outer surface of the hub ring 21. The riblets 14 are designed according to FIG. 4 in order to avoid undercuts during the demolding process (the relative demolding direction of the tool part for the flowed-around surface 13 and which is formed by the outer surface of the hub ring 21 is approximately perpendicular to the plane of view toward the observer).

Impellers 19 are components that rotate during operation and transmit power. The reduction of a wall shear stress of an impeller 19 in the circumferential direction leads to a reduction in the torque loss. In a flow machine in which power is transmitted from the impeller to the fluid, this reduces the required drive torque and thus the required drive power. In a flow machine in which power is transferred from the fluid to the impeller, the reduction in the torque loss increases the effective drive torque transmitted to the impeller and the transmitted drive power. FIG. 6 shows, in a perspective view viewed from the inflow side, a housing 2 of an axial fan with a schematically represented course of riblets on the air-guiding surfaces 13. A housing is a stationary, non-driven component and wall shear stresses do not contribute to drive torques or drive power. Nevertheless, the reduction of wall shear stresses can contribute to an increase in the delivery flow rate and thus to the increase in efficiency and also to an improvement in acoustic performance. In any case, the housing 2 is a flowed-around component 1 of a flow machine.

The housing comprises an outer ring 4, comprising an integrated inlet nozzle 9, a running area for an impeller (not shown) and a diffuser area, within which an integrated guide device 15 is arranged. The guide device 15 comprises outer strut elements 3a, a circumferential intermediate ring 5, inner guide elements 3, and a hub ring 10. A motor (not shown) with the impeller of a fan can be attached to the hub ring, and the guide device 15 connects the outer ring 4 of the housing 2 to the hub ring 10 and thus holds the motor with the impeller with regard to the outer ring 4, at which the housing 2 can be attached to a higher-level system.

In the assembled entire fan (not shown in its entirety), an impeller runs inside the housing 2 or its outer ring 4 on the inflow side of the guide device 15 and conveys, driven by a motor, a conveying medium in the conveying direction, approximately from left to right, which enters the housing 2 at the inlet nozzle 9 and downstream of the guide device 15 exits the housing 2. In any case, there are a plurality of flowed-around surfaces 13 on the housing 2 shown, as illustrated. These include the inner surface of the inlet nozzle 9, the surfaces of the strut elements 3a, the guide elements 3, the intermediate ring 5, and the hub ring 10. Riblets 14 with a suitable geometric design can be attached to all these surfaces to minimize wall friction and thus flow losses, thereby contributing to an increase in efficiency and a reduction in noise emissions.

The riblets 14 are designed as shown in FIG. 4 and in this respect, where necessary, their cross-section is adjusted to ensure undercut-free demolding. The longitudinal course of the riblets 14, which is indicated in the illustration according to FIG. 6 with the aid of the course of a few riblets 14 illustrated by way of example, is advantageously always chosen to be approximately parallel to the local relative flow velocity with respect to the flowed-around surface 13. In this example of a flowed-around component 1,2, comparable to the component shown in FIG. 1, the relative demolding directions of the shaping tool parts are predominantly oriented parallel to the central axis of the component.

For the sake of completeness, it should be mentioned that the riblets 14 on the inner contour of the inlet nozzle 9 do not have any circumferential component in their longitudinal course, corresponding to the expected direction of flow over the corresponding flowed-around surface 13. It is therefore possible and advantageous to create riblet cross-sections that are symmetrical to the local wall normal without obtaining undercuts when demolding the housing 2 with a demolding direction parallel to the housing axis. This is because in a section on a plane perpendicular to the longitudinal course of the riblets 14 and perpendicular to the local base area of the flowed-around surface 13 according to FIG. 4, there would be no undercut between the (projected) demolding direction and the riblets 14.

Advantageously, a component 1 in other words a flowed-around component 1 has riblet cross-sections that are symmetrical with respect to the local wall normal viewed in the cross-section, as long as this is possible due to the demolding directions without local undercuts while maintaining effective riblet cross-sections, and asymmetrical riblet cross-sections wherever this is necessary due to the demolding direction in order to ensure undercut-free demolding.

There are a number of other conceivable flowed-around components 1 of flow machines and such components can be advantageously provided with riblets in the manner described. Special mention should be made of spiral housings of radial or diagonal fans, wherein it is advantageously possible to provide on their flow-guiding inner contours riblets with the described geometric design of the cross-sections, oriented approximately in the circumferential direction of the installed impeller. The riblets are integrated into the component in a single casting process during manufacture, which means that the respective component can be manufactured cost-effectively in mass production.

With regard to further advantageous designs of the flow machine according to the present disclosure, reference is made to the general part of the description and to the appended claims in order to avoid repetition.

Finally, it should be expressly noted that the above described exemplary embodiments of the flow machine according to the present disclosure serve only to discuss the claimed doctrine and do not limit it to the exemplary embodiments.

### LIST OF REFERENCE CHARACTERS

1, 1a Flowed-around component
2 Housing
3 Guide element, guide blade
3a Strut element
4 Outer ring of a housing
5 Intermediate ring of a guide device
6 Outer through-flow area
7 Inner through-flow area
8 Receiving area within the hub ring
9 Inlet nozzle
10 Hub ring of a guide device
11 Inner contour of the housing
12, 12a Demolding direction of a tool part relative to the component
13, 13a Air-guiding surface, flowed-around surface
14, 14a Riblet
15 Guide device
16 Circumferential cover ring of an impeller
17, 17a Shaping tool part
18, 18a Side flank of a riblet
19 Impeller
20,20a Outer edges of a riblet
21 Hub ring of the impeller
22 Blade of the impeller
23 Base area of an air-guiding surface
24, 24a Head area of a riblet
25 Outflow-side rim of the housing
26 Axis of the fan
27 Inflow edge
28 Outflow edge
29 Inner edges at the transition riblet—base area

1. A flow machine, such as a fan, comprising:
at least one component that guides a flow medium, wherein the component which guides the flow medium is produced from synthetic material by casting; wherein riblets are formed on and/or in the surface of the component in an area around which flow takes place.

2. The flow machine as claimed in claim 1, wherein the riblets are formed on the respective component in an area of high flow losses and/or noise generation.

3. The flow machine as claimed in claim 1, wherein the riblets are formed as elongated, structures approximately parallel to the direction of flow over them.

4. The flow machine as claimed in claim 1, wherein the riblets are formed in a straight line or curved.

5. The flow machine as claimed in claim 1, wherein multiple riblets are arranged in a manner suitable for a specific component in at least one of a linear arrangement adjacent to one another and, at least two arrangements of riblets are arranged at least partially parallel to one another.

6. The flow machine as claimed in claim 1, wherein the riblets are formed in a manner suitable for a specific component in an arrangement in the shape of a circular arc, an involute curve or otherwise curved and are arranged adjacent to one another, and wherein where appropriate, two such arrangements of riblets are arranged parallel to one another.

7. The flow machine as claimed in claim 1, wherein at least a portion of the riblets are designed with regard to a demolding direction of the tools free of undercuts and have a draft angle of at least 1°.

8. The flow machine as claimed in claim 1, wherein the riblets viewed in the cross-section with respect to side flanks of the riblets are not symmetrical with respect to a local normal on the surface of the at least one components, which is not parallel to the demolding direction,.

9. The flow machine as claimed in claim 1, wherein the at least one component including the riblets can be demolded in one piece and free of undercuts from a casting tool.

10. The flow machine as claimed in claim 1, wherein at least an area of the riblets is made of a thermoplastic synthetic material with fiber reinforcement.

11. A method for producing a component which guides a flow medium for a flow machine as claimed in claim 1, wherein the at least one component which guides a flow medium is equipped at least in sections with riblets, produce by means of injection molding technology using shaping tools, wherein negative contours of the riblets are formed in the tools.

12. The method as claimed in claim 11, wherein the tool surfaces in which the negative curves of the riblets are formed are surface-treated to obtain a low degree of roughness or roughness depth with a roughness depth of less than 10 μm.

13. The method as claimed in claim 11, wherein the contours of the riblets are subsequently introduced into the tool that has already been put into operation.

14. The method as claimed in claim 11, wherein at least individual areas of the injection molding tool on surfaces that form riblets are tempered to a higher temperature during manufacture than other areas that do not form riblets.

15. The flow machine as claimed in claim 1, wherein component that guides a flow medium comprises at least one of:
blades of an impeller,
guide blades,
a hub ring,
a cover ring,
a base plate,
a nozzle, and
housing parts

16. The flow machine as claimed in claim 1, wherein the at least one component is an injection molded component.

17. The flow machine as claimed in claim 7, wherein the riblets have a draft angle of at least 3°.
